(19) United States
(12) Patent Application Publication
(10) Pub. No.: US 2013/0226747 A1
(43) Pub. Date: Aug. 29, 2013

(54) BUSINESS MANAGEMENT DEVICE

(71) Applicants: Naoyuki Morita, Tokyo (JP); Takanori Yamaoka, Tokyo (JP); Yoshaku Koh, Tokyo (JP); Kohtaro Mori, Tokyo (JP); Katsumasa Aoki, Tokyo (JP)

(72) Inventors: Naoyuki Morita, Tokyo (JP); Takanori Yamaoka, Tokyo (JP); Yoshaku Koh, Tokyo (JP); Kohtaro Mori, Tokyo (JP); Katsumasa Aoki, Tokyo (JP)

(73) Assignee: KCCS MANAGEMENT CONSULTING, INC., Tokyo (JP)

(21) Appl. No.: 13/521,182

(22) PCT Filed: Oct. 19, 2011
(86) PCT No.: PCT/JP2011/005845

§ 371 Date: Jul. 9, 2012

(30) Foreign Application Priority Data
Oct. 28, 2010 (JP) 2010-242637

(51) Int. Cl. G06Q 40/00

(52) U.S. Cl. CPC G06Q 40/10
USPC 705/30

(57) ABSTRACT

The invention provides a system that not only calculates incomes and expenses on a really existing in-house organization (for example, Amoeba (trademark)), but also calculates incomes and expenses on a virtual in-house organization that is predetermined for each product or each service. Compensation-for-cooperation data generating means 4 refers to a compensation-for-cooperation table 8 to determine a specific virtual in-house organization that is identified in given income data, a specific really existing in-house organization that conducts corporative buying and selling with the specific virtual in-house organization, and a monetary value of the corporative buying and selling. Compiled management data generating means 6 compiles compensation-for-cooperation data and accounting data including income data and expense data on a really existing in-house organization basis to calculate a profit, thus to generate first compiled management data on a really existing in-house organization basis. In addition, the compiled management data generating means 6 compiles the compensation-for-cooperation data and the accounting data including the income data and the expense data on a virtual in-house organization basis to calculate a profit, thus to generate second compiled management data on a virtual in-house organization basis.

### TECHNICAL FIELD

The present invention relates to a business management system that allows for clear understanding of a management status.

### BACKGROUND ART

Amoeba Management (trademark) is known as a business approach to managing profitability on a department basis (for example, Patent Document 1). The Amoeba Management (trademark) is a business management system based on an idea that a company should not be managed by only top executives, but all employees of the company should be involved in management of the company. The business management system is designed to divide the whole company into small organizations as much as possible to clearly show results from their work in the respective organizations. This encourages all the employees to participate in the management of the company.

A feature of the Amoeba Management (trademark) is that small organizations called Amoeba (trademark) are established within a company to calculate incomes, expenses, a profit, and a profit per unit time on an Amoeba (trademark) basis, thus to provide timely business management information.

For example, in a case where a manufacturer produces products through a plurality of processes, organizations in charge of the respective processes are defined as Amoebas (trademark). Each Amoeba (trademark) in charge of one of the processes sells intermediate products to another Amoeba (trademark) in charge of the next process (hereinafter referred to as in-house buying and selling). A sales price of the intermediate product is recorded as sales. There have been some conventional management systems that calculate a monetary value in inter-process trade. However, in the conventional management systems, a sales price of the intermediate products supplied from one process to the next process is regarded as a manufacturing cost. In other words, there does not exist a concept that a profit is calculated in each process.

In contrast, the Amoeba Management (trademark) is constructed to generally determine a sales price for the in-house buying and selling by a negotiation between the Amoebas (trademark) in order to help the Amoebas basically obtain a profit from the in-house buying and selling. This allows the respective Amoebas (trademark) to increase their profits as their work efficiency improves, and thus encourages employees, who belong to each of the Amoebas (trademark), to participate in the management of the company.

### PRIOR ART DOCUMENT

### Patent Document 1: JP-A-2009-187469

### SUMMARY OF THE INVENTION

### Problem to be Solved by the Invention

As described above, the Amoeba Management (trademark) system is designed to establish small organizations called Amoeba (trademark) to specify incomes and expenses on an Amoeba (trademark) basis, and thus to boost morale of the employees who belong to each of the Amoebas (trademark). Usually employees who work on a certain process or task are collected in a group and this group is defined as an Amoeba (trademark).

The Amoeba Management (trademark) system only provides business management information on the incomes and expenses calculated on the basis of an Amoeba (trademark) that consists of persons. Thus, there has been a strong demand for such a system that also provides business management information on incomes and expenses calculated on a product basis or on a service basis.

Unfortunately, because the Amoeba (trademark) consists of persons, the Amoeba (trademark)-based calculation of the incomes and expenses has to be performed in a completely different manner from the product-based or service-based calculation of the incomes and expenses. Different inputs and different computations are required for such calculations. This makes the calculation process more complicated. In addition, if the incomes and expenses of the human-based organization and the incomes and expenses of the product-based or service-based unit are calculated independently, checking on a discrepancy (for example, whether the total incomes and expenses on both sides are the same) between both becomes necessary. This also makes the calculation process more complicated.

Further, there is a case that a calculation of the incomes and expenses of a unit such as project team, which are formed with persons but not a primary in-house organization, is needed in addition to the calculation of the incomes and expenses of an Amoeba (trademark), which is an in-house organization formed with persons. This case also creates the same problems as in the cases described above.

The present invention has been made to solve the foregoing problems. An object of the present invention is to provide a system that reduces burden of data input and computation to not only calculate incomes and expenses on the basis of a primary in-house organization (for example, Amoeba (trademark)) that consists of persons, but also calculate incomes and expenses on a product basis or on a service basis, or to calculate incomes and expenses on the basis of an secondary in-house organization (for example, a project team), while generally eliminating the need for a separate check of a discrepancy between the calculations.

### Means for Solving the Problem

(1) (2) One aspect of the present invention is directed to a business management system comprising:

a recording part that records first compiled management data on each of a plurality of really existing in-house organizations, second compiled management data on each of a plurality of virtual in-house organizations that are established across the plurality of really existing in-house organizations, and a compensation-for-cooperation table, in which the first compiled management data includes: income data derived from a supply of services or a sale of goods; compensation-for-cooperation data for the other really existing in-house organization; expense data; and profit data, the second compiled management data includes: income data derived from a supply of services or a sale of goods; compensation-for-cooperation data for the really existing in-house organization; expense data; and profit data, and the compensation-for-cooperation table is designed to determine a monetary value of cooperative buying and selling between the virtual in-house organization and the really existing in-house organization, corresponding to the income data;

inputting part which inputs accounting data including the income data associated with the virtual in-house organization and the expense data;

means for generating compensation-for-cooperation data including at least in-house income data of the really existing in-house organization from the virtual in-house organization by referring to the compensation-for-cooperation table in response to the income data associated with the virtual in-house organization; and

means for generating first compiled management data including the profit data calculated by compiling the inputted income data and the expense data associated with the virtual in-house organization, and the generated compensation-for-cooperation data on the really existing in-house organization basis and for generating second compiled management data including the profit data calculated by compiling the inputted income data and the expense data associated with the virtual in-house organization, and the generated compensation-for-cooperation data on the virtual in-house organization basis.

Thus, the business management system allows incomes and expenses to be easily calculated not only on a really existing in-house organization basis, but also on a virtual in-house organization basis, while making data input less complicated.

(3) In accordance with the business management program of the present invention, the compensation-for-cooperation data generating means may generate the compensation-for-cooperation data including: the in-house income data on the really existing in-house organization in relation to the corresponding virtual in-house organization; and in-house cost data on the virtual in-house organization corresponding to the in-house income data.

Thus, the business management program allows profit management for the really existing in-house organizations.

(4) In accordance with the business management program of the present invention, the compensation-for-cooperation data generating means may generate the compensation-for-cooperation data including: the expense data on the virtual in-house organization; and expense data on the really existing in-house organization corresponding to the expense data on the virtual in-house organization, and the expense data on the really existing in-house organization may be shown as a negative number.

Thus, the business management program eliminates the need for profit management in consideration of incomes derived from in-house trading for the really existing in-house organizations, so that expense management only needs to be performed for the really existing in-house organizations.

(5) In accordance with the business management program of the present invention, data that integrates the second compiled management data on the respective virtual in-house organizations may be equal to the first compiled management data on the really existing in-house organization into which the virtual in-house organizations are integrated.

Thus, the business management program allows all the management data on the virtual in-house organizations to be integrated together through the really existing in-house organization.

(6) In accordance with the business management program of the present invention, a secondary really existing in-house organization may be used in place of, or in addition to, the virtual in-house organization, and the secondary really existing in-house organization may be organized across the really existing in-house organizations.

Thus, the business management program is applicable to a cross-functional in-house organization, such as a project team.

(7) Still another aspect of the present invention is directed to a business management method that generates first compiled management data on each of a plurality of really existing in-house organizations and second compiled management data on each of a plurality of virtual in-house organizations that are established across the plurality of really existing in-house organizations, in which the first compiled management data includes: income data derived from a supply of services or a sale of goods; compensation-for-cooperation data for the other really existing in-house organization; expense data; and profit data, and the second compiled management data includes: income data derived from a supply of services or a sale of goods; compensation-for-cooperation data for the really existing in-house organization; expense data; and profit data, the business management method being executed by a computer having a recording section that records a compensation-for-cooperation table designed to determine a monetary value of cooperative buying and selling between the virtual in-house organization and the really existing in-house organization, corresponding to the income data; in which the computer is programmed to: refer to the compensation-for-cooperation table in response to the income data associated with the virtual in-house organization to generate the compensation-for-cooperation data including at least in-house income data on the really existing in-house organization in relation to the corresponding virtual in-house organization; and compile the inputted income data associated with the virtual in-house organization, the expense data, and the generated compensation-for-cooperation data on the really existing in-house organization basis to calculate the profit data, thus to generate the first compiled management data, and compile the inputted income data associated with the virtual in-house organization, the expense data, and the generated compensation-for-cooperation data on the virtual in-house organization basis to calculate the profit data, thus to generate the second compiled management data.

Thus, the business management system allows incomes and expenses to be easily calculated not only on a really existing in-house organization basis, but also on a virtual in-house organization basis, while making data input less complicated.

The “accounting data input part” is used to input the accounting data, and corresponds to a communication circuit 30 and a mouse/keyboard 26 in the embodiment of the present invention.

The “compensation-for-cooperation data generating means” corresponds to the step S3 in FIG. 5 in the embodiment of the present invention.

The “compiled management data generating means” corresponds to the steps S5 to S8 in FIG. 5 and FIG. 6 in the embodiment of the present invention.

The scope of the definition of the “program” covers not only a program that can be directly executed by a CPU, but also a source form program, a compressed program, and an encrypted program.

### BRIEF DESCRIPTION OF THE DRAWINGS

FIG. 1 is a functional block diagram of a business management system according one embodiment of the present invention;

FIG. 2 illustrates a relationship between really existing in-house organizations and virtual in-house organizations;

FIG. 3 illustrates a hardware configuration of the business management system;

FIG. 4 illustrates an example of accounting data;

FIG. 5 is a flowchart of a business management program 42;

FIG. 6 is a flowchart of the business management program 42;

FIG. 7 illustrates an example of a compensation-for-cooperation table 8;

FIG. 8 illustrates an example of generated compensation-for-corporation data;

FIG. 9 illustrates an example of generated first compiled management data 10;

FIG. 10 illustrates an example of generated second compiled management data 12;

FIG. 11 illustrates a relationship between really existing in-house organizations and virtual in-house organizations according to another embodiment of the present invention;

FIG. 12 illustrates a relationship between really existing in-house organizations and virtual in-house organizations according to still another embodiment of the present invention; and

FIG. 13 illustrates a relationship between really existing in-house organizations and secondary really existing in-house organizations.

### DESCRIPTION OF THE PREFERRED EMBODIMENTS

### 1. Overview

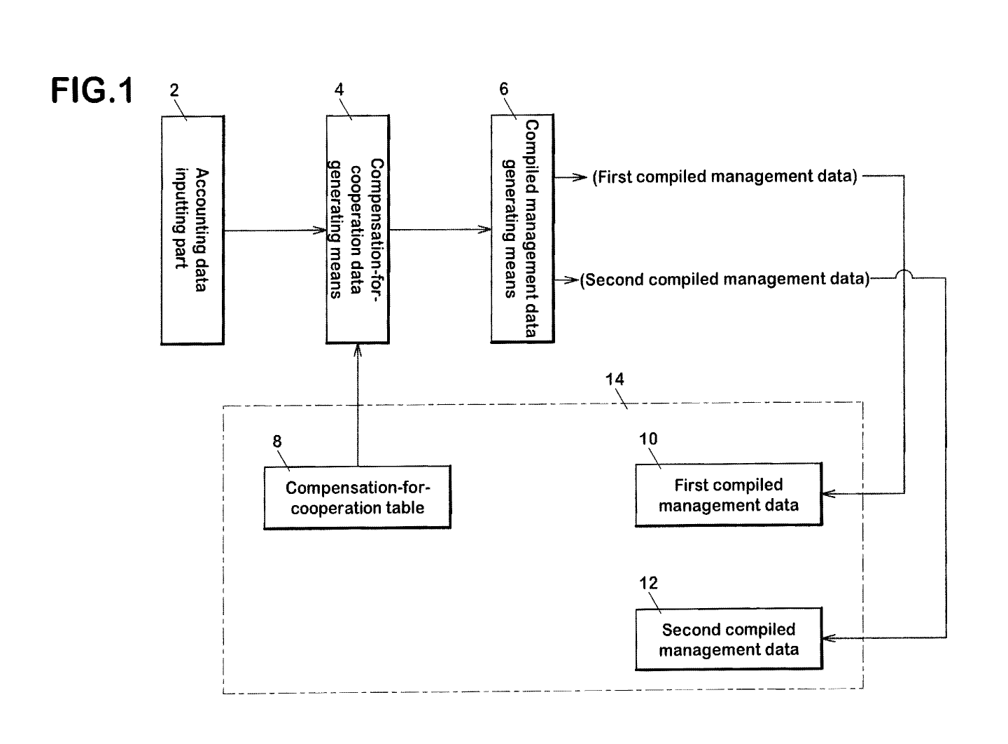

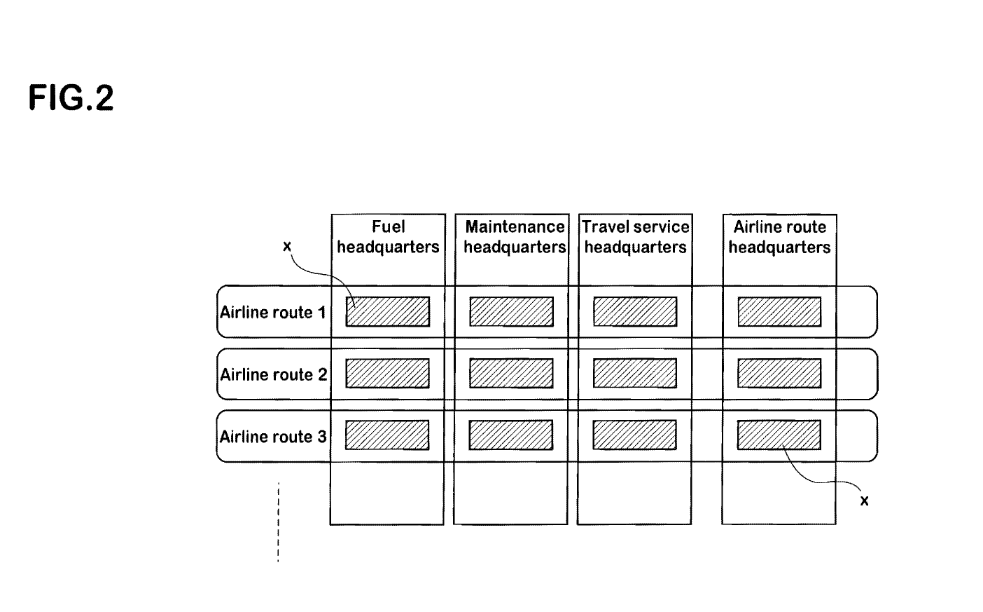

FIG. 1 illustrates a functional block diagram of a business management system according one embodiment of the present invention. In this embodiment, an airline company that operates airline routes will be described as an example. The business management system calculates incomes and expenses respectively for really existing in-house organizations and calculates incomes and expenses respectively for virtual in-house organizations. As shown in FIG. 2, the really existing in-house organizations are a fuel headquarters, a maintenance headquarters, a travel service headquarters, and an airline route headquarters. In turn, the virtual in-house organizations are airline routes that are operated by the airline company.

The fuel headquarters is a department for purchasing fuel to be used for aircraft. The maintenance headquarters is a department for maintaining the aircraft. The travel service headquarters is a department to which pilots belong. The airline route headquarters is a department responsible for incomes and expenses derived from the airline routes such as Itami—Haneda, from Haneda—Sapporo.

In FIG. 1, an accounting data inputting section 2 receives accounting data including income data and expense data. The income data is associated with one of the virtual in-house organizations. Corresponding to the income data, a compensation-for-cooperation table 8 stores data to be used for determining a monetary value of cooperative buying and selling between the virtual in-house organization and the really existing in-house organization. The compensation-for-cooperation table 8 is recorded in a recording section 14.

Compensation-for-cooperation data generating means 4 refers to the compensation-for-cooperation table 8 to determine a specific one of the virtual in-house organizations, which is identified in the given income data, a specific one of the really existing in-house organizations, which conducts corporative buying and selling with the specific virtual in-house organization, and the monetary value of the corporative buying and selling. The compensation-for-cooperation data thus generated includes in-house income data on the really existing in-house organization in relation to the corresponding virtual in-house organization.

Compiled management data generating means 6 compiles the compensation-for-cooperation data and the accounting data including the income data and the expense data on a really existing in-house organization basis to calculate a profit, and thus to generate first compiled management data on a really existing in-house organization basis. In addition, the compiled management data generating means 6 compiles the compensation-for-cooperation data and the accounting data including the income data and the expense data on a virtual in-house organization basis to calculate a profit, thus to generate second compiled management data on a virtual in-house organization basis.

### 2. Hardware Configuration

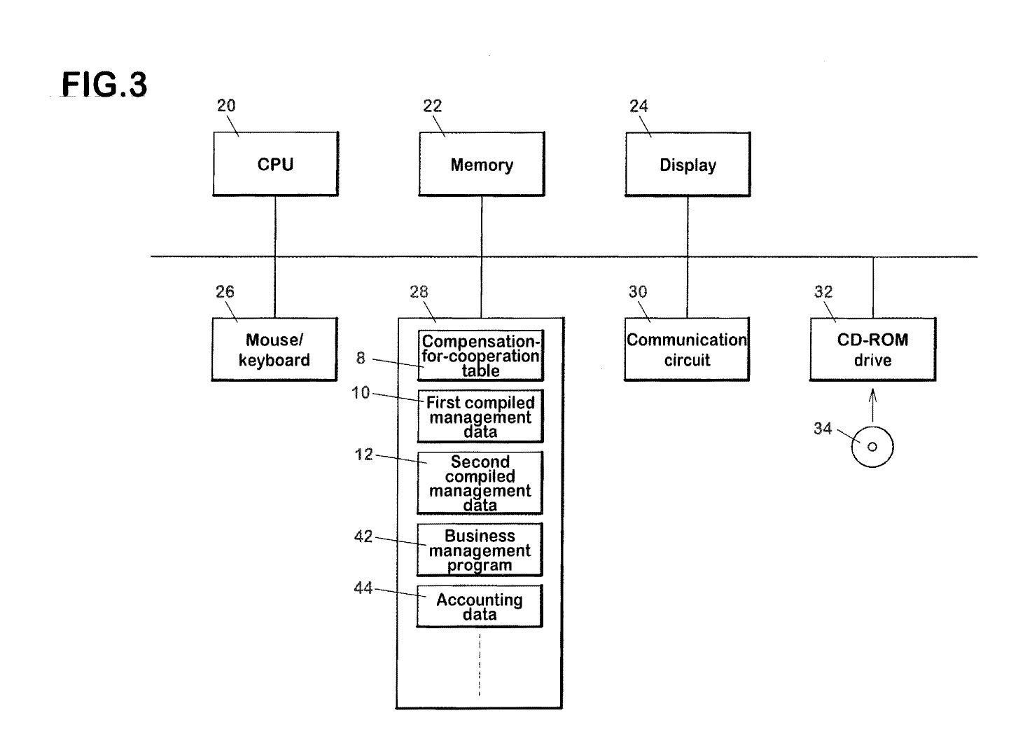

FIG. 3 illustrates a hardware configuration of the business management system. A CPU 20 is connected to a memory 22, a display 24, a mouse/keyboard 26, a hard disk 28, a communication circuit 30, and a CD-ROM drive 32.

On the hard disk 28, the compensation-for-cooperation table 8 and a business management program 42 are recorded. The mouse/keyboard 26 is designed to input the accounting data including the income data and the expense data. The business management program 42 is first recorded on a CD-ROM 34 and is then installed in the hard disk 28 through the CD-ROM drive 32. On the hard disk 28, an operating system (not shown) is recorded. The business management program 42 cooperates with the operating system to fulfill its function.

The communication circuit 30 is designed to communicate with another computer through LAN etc. The accounting data inputted from the other computer is received through the communication circuit 30.

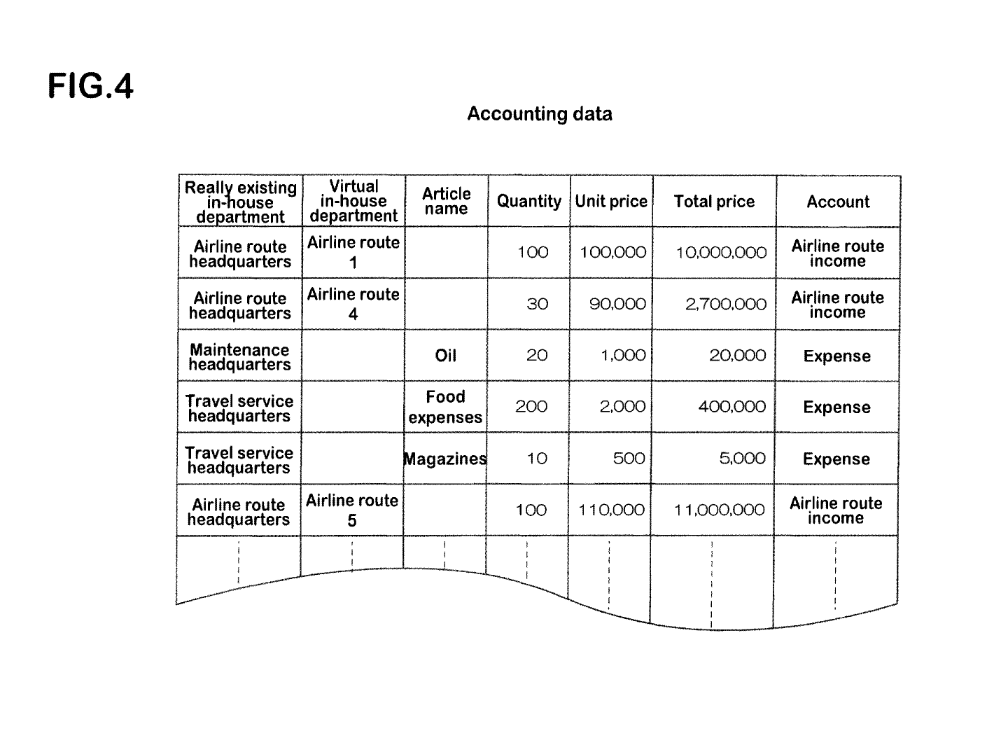

In this embodiment, the accounting data is inputted from a separate terminal computer, and is then obtained through the communication circuit 30 to be stored in the hard disk 28. FIG. 4 illustrates an example of the accounting data 44 stored in the hard disk 28. Each record of the accounting data indicates which really exist department (really existing in-house organization) the record of the accounting data belongs to. If a record of the accounting data is related to one of the virtual departments (virtual in-house organizations), the name of the virtual departments (a name of the airline route in this embodiment) is also shown. If an article falls under consumables or purchased goods, and is related to all the virtual departments or is not determined to which virtual departments the article is to be supplied, virtual department field is left blank. In addition, a category field specifies whether each record of the accounting data is income or expense.

### 3. Processing of Business Management Program 42

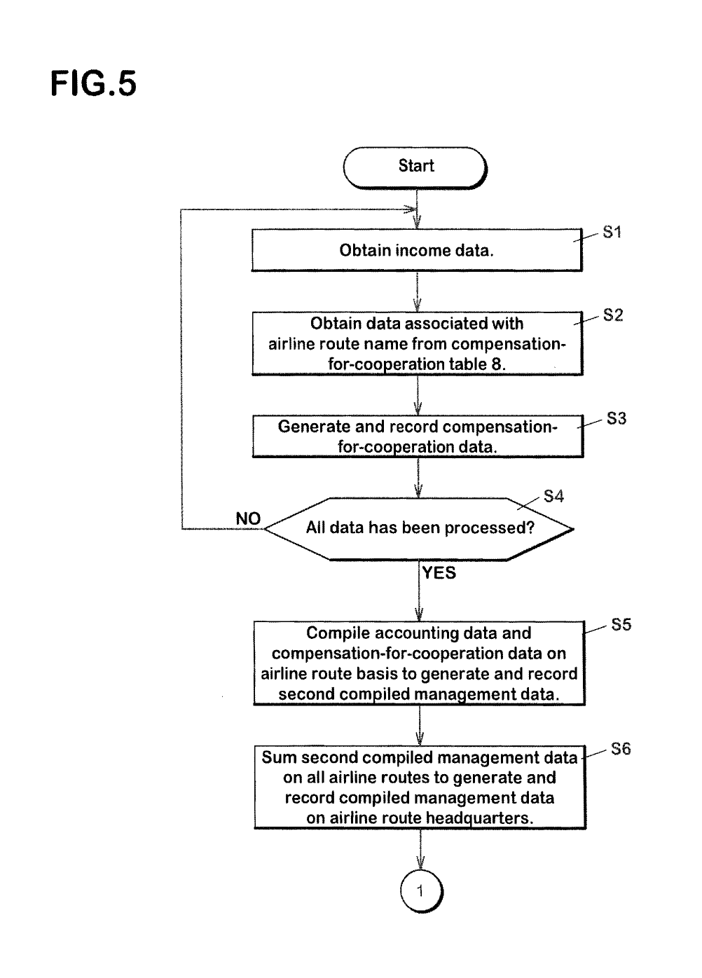

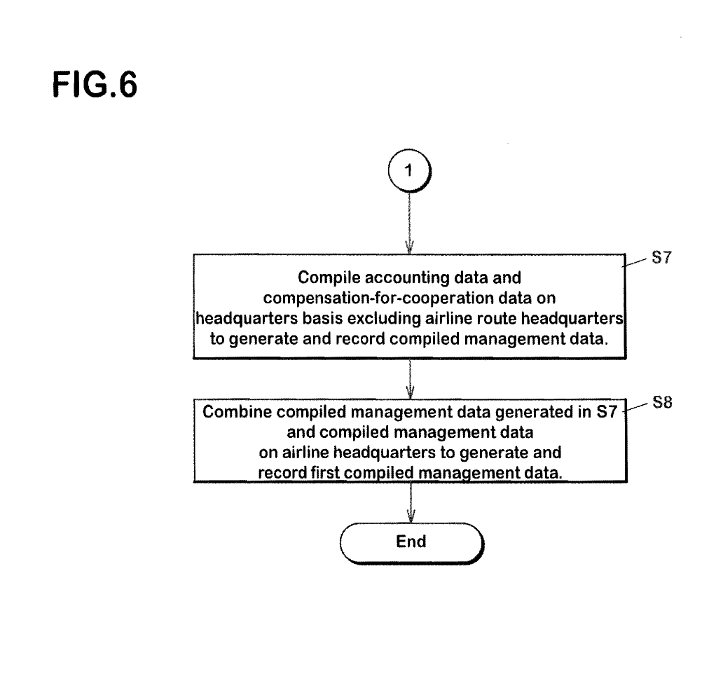

FIG. 5 and FIG. 6 illustrate a flowchart of the business management program 42. In this embodiment, processing of the program shown in FIG. 5 and FIG. 6 is executed every day. Thus, all the accounting data stored for one day is subjected to the processing.

The CPU 20 obtains the income data from the accounting data stored in the hard disk 28 (the step S1). In the case of the accounting data 44 shown in FIG. 4, the CPU 20 first obtains the first line data that has “airline route income” in the category field.

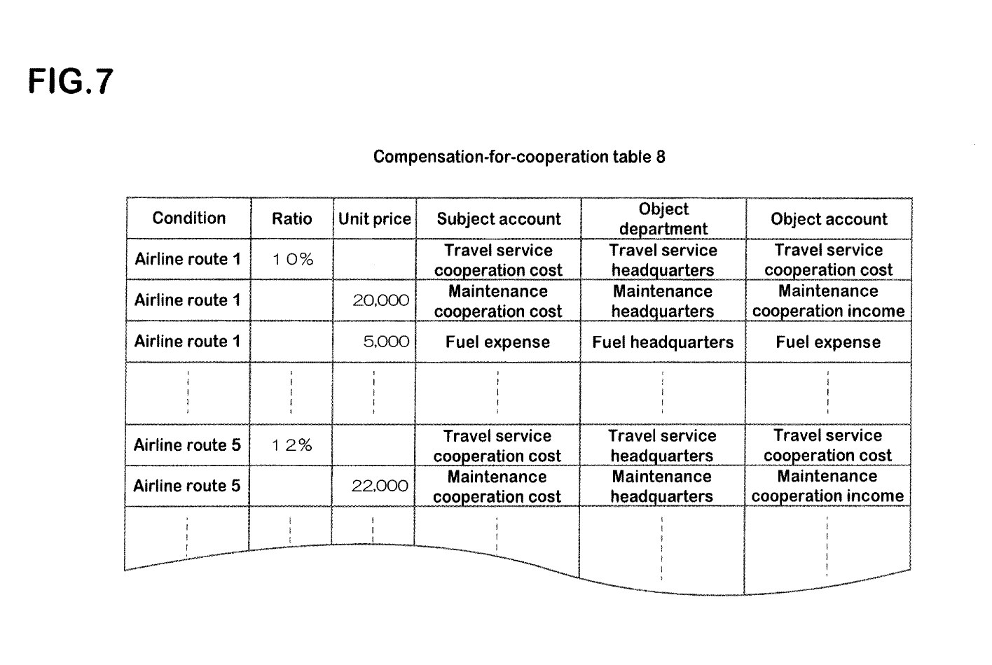

Next, from the compensation-for-cooperation table 8, the CPU 20 obtains data associated with the name of the virtual department (the name of the airline route) that is indicated in the obtained income data (the step S2). FIG. 7 illustrates an example of the compensation-for-cooperation table 8. The compensation-for-cooperation table 8 shows standards for allocating incomes derived from a virtual department or an airline route to a really exist department that cooperates with the virtual department or the airline route. The allocation depends on the degree of cooperation by the really exist department. In this embodiment, these standards are formalized and defined respectively for the airline routes. A percentage of the allocation and an amount of the allocation are determined depending on the type of the aircraft used for the airline route, the traveling distance, and so on.

In FIG. 7, a “condition” field indicates to which airline route the data is applied. In addition, a “ratio” field indicates the percentage of the allocation, while a “unit price” field indicates the amount of the allocation. Also in FIG. 7, a “subject account” field indicates the name of the account shown in the compensation-for-cooperation data to be generated for the applicable virtual department as a result of the allocation. In addition, an “object department” field indicates the name of the object department that receives the allocation. An “object account” field indicates the account title, shown in the compensation-for-cooperation data, to be generated in the object department as a result of the allocation.

In the step S2 in FIG. 5, the CPU 20 obtains from the compensation-for-cooperation table 8 in FIG. 7 the data associated with the virtual department “airline route 1” on the first line of the accounting data in FIG. 4. In this case, the CPU 20 obtains the data on the first line to the third line of the compensation-for-cooperation table 8.

Next, the CPU 20 generates compensation-for-cooperation data based on the obtained income data and the data obtained from the compensation-for-cooperation table 8 (the step S3).

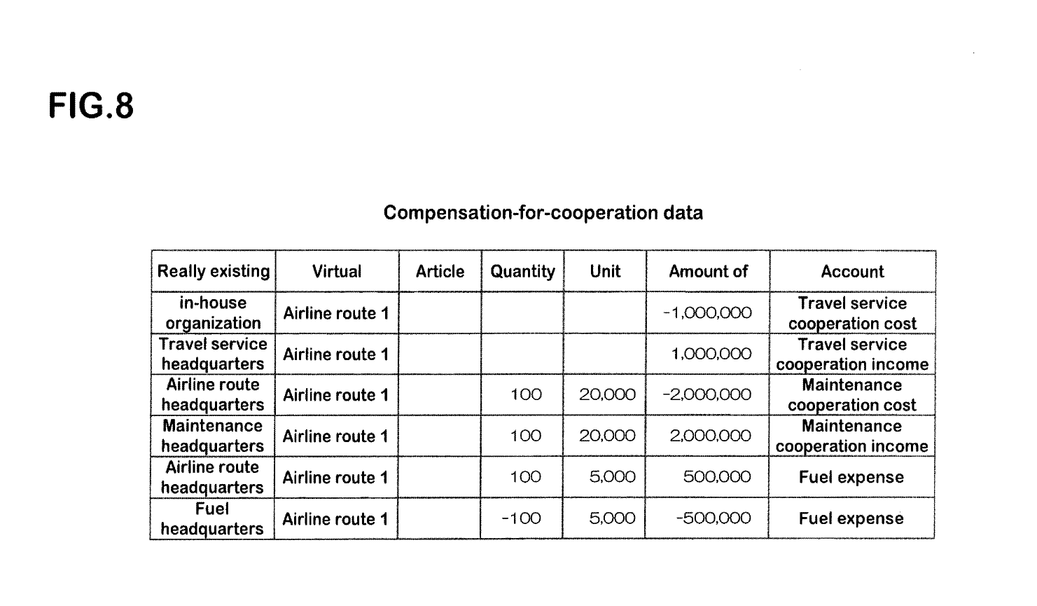

The ratio 10% is shown on the first line data in the compensation-for-cooperation table 8 in FIG. 7. Accordingly, the CPU 20 multiplies “total price” 10,000,000 yen, which is obtained from the first line income data in FIG. 4, by 10% to arrive at the amount of the allocation 1,000,000 yen. In the “subject account” field, travel service cooperation cost is shown. Thus, as shown by the first line data in FIG. 8, travel service cooperation cost is inputted into the “category” field, while −1,000,000 yen is inputted into an “amount of allocation” field to generate the compensation-for-cooperation data on the airline route 1. The amount of allocation is shown as a negative number because the account represents a cost.

According to the first line data in the compensation-for-cooperation table in FIG. 7, travel service headquarters is shown in the “object department” field and travel service cooperation income is shown in the “object account” field. Thus, as shown in the second line data in FIG. 8, for the travel service headquarters and the airline route 1 in the compensation-for-cooperation data, 1,000,000 yen is entered in the “amount of allocation” field, and the “travel service cooperation income” is entered in the account field.

The aforementioned compensation-for-cooperation data shows that the income data derived from the airline route 1 is allocated to the travel service headquarters. More specifically, the compensation-for-cooperation data shows on the first line that the airline route 1 incurs a cost derived from in-house trading, while showing on the second line that the travel service headquarters earns an income derived from the in-house trading.

In the aforementioned manner, processing of the first line data in the compensation-for-cooperation table 8 in FIG. 7 is complete. The second line data in the compensation-for-cooperation table 8 is also associated with the airline route 1. Therefore, this second line data is also processed in the same manner as described above. As a consequence of the processing of the second line data, the compensation-for-cooperation data is generated as shown by the third and fourth lines in FIG. 8.

Next, the CPU 20 generates the compensation-for-cooperation data based on the third line data in the compensation-for-cooperation table 8 in FIG. 7. According to the third line data in the compensation-for-cooperation table 8, the fuel headquarters is shown in the “object department” field. In this embodiment, the travel service headquarters and the maintenance headquarters are considered as a profit center that generates more incomes (including a cooperation income derived from the in-house trading). Thus, the incomes and expenses for the travel service headquarters and for the maintenance headquarters are both calculated independently. The travel service headquarters and the maintenance headquarters can increase their profits by improving work efficiency or by other approach. This also serves the purpose of the company.

In contrast, in this embodiment, the fuel headquarters only purchases fuel from an outside source, and is not therefore expected to increase its profit by improving work efficiency or by other approach. Thus, such a department as the fuel headquarters earns no income derived from the in-house trading, but records only a fuel expense. It should be understood that the fuel headquarters may be considered as a profit center, provided that the company has determined that the fuel headquarters can increase its profit by central buying or by other efforts in accordance with the company's policy.

Only the fuel expense is recorded for the fuel headquarters. Thus, as shown by the third line data in the compensation-for-cooperation table 8 in FIG. 7, both of the “subject account” field and the “object account” field are recorded as fuel expense. No cooperation income is recorded for the fuel headquarters. Therefore, the generated compensation-for-cooperation data shows, on the fifth line, 500,000 yen of fuel expense for the airline route 1, while showing, on the sixth line, −500,000yen of fuel expense and −100 inputted into a quantity field for the fuel headquarters. In other words, the fuel expense incurred by the fuel headquarters that purchases fuel is transferred to the airline route 1. In this case, the quantity is shown as a negative number, and accordingly the amount of allocation is shown as a negative number.

Therefore, assuming that the fuel headquarters supplies all its purchased fuel to the respective airline routes, the fuel headquarters earns no profit and no loss. Actually, the fuel headquarters needs to stock fuel. Thus, a monetary value equivalent to the fuel stock is shown as a negative profit for the fuel headquarters. It should be understood that expenses of the indirect departments may be borne by all the departments at a rate depending on the number of employees in each of the departments in the name of business establishment operating expenses or the like.

As described above, the CPU 20 generates the compensation-for-cooperation data based on the first line data in the accounting data shown in FIG. 4.

Next, the CPU 20 determines whether or not all the income data in the accounting data has been processed (the step S4). If any of the income data has not yet been processed, the CPU 20 repeats the step S1 and the subsequent steps to generate the compensation-for-cooperation data.

When all the income data has been completely processed, the CPU 20 goes to the step S5. In the step S5, the CPU 20 compiles the accounting data and the generated compensation-for-cooperation data on an airline route basis to generate second compiled management data 12.

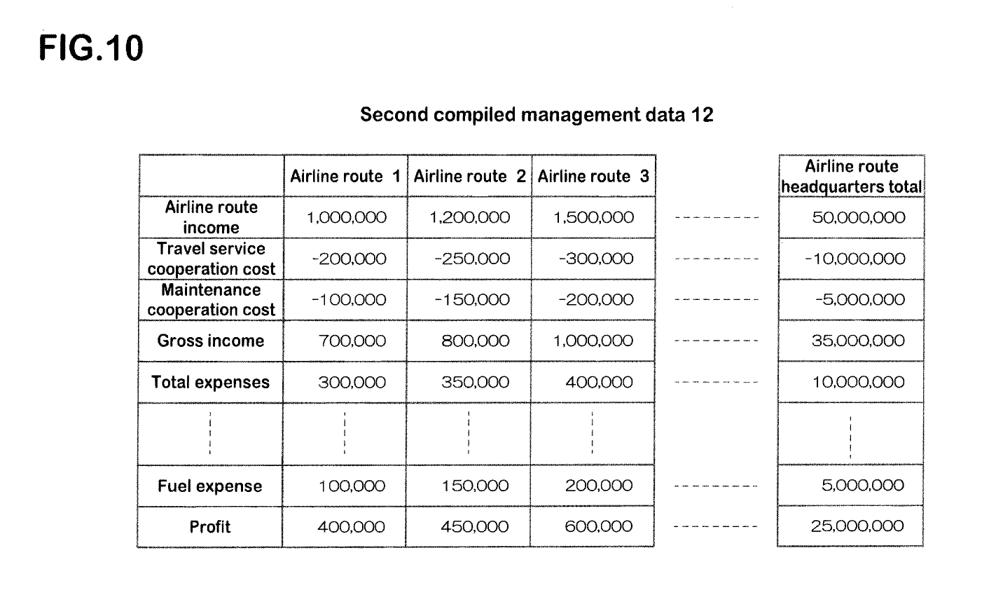

FIG. 10 illustrates the second compiled management data 12 thus generated. The CPU 20 calculates a total of the airline route incomes and individual totals of the travel service cooperation costs, the maintenance cooperation costs, and so on in the compensation-for-cooperation data on an airline route basis. Then, the CPU 20 adds the totals together to calculate gross income. In addition, the CPU 20 calculates individual totals of the respective expenses including the fuel expense, and adds the totals together to calculate total expenses. Further, the CPU 20 subtracts the total expenses from the gross income to calculate a profit. The CPU 20 records the second compiled management data 12 thus calculated on the hard disk 28.

The calculated second compiled management data 12 helps to clarify the incomes and expenses on an airline route basis, while helping to specifying a breakdown of the incomes and a breakdown of the expenses. This can be reflected to the management policy.

Next, the CPU 20 sums the calculated second compiled management data 12 on all the airline routes to generate compiled management data on the airline route headquarters (step S6). FIG. 10, at the right end thereof, illustrates the thus-generated compiled management data on the airline route headquarters. In this embodiment, the compiled management data on the airline route headquarters is obtained by summing the data on all the airline routes. This eliminates a risk of a discrepancy between the data of each airline route and the compiled management data of the airline route headquarters. Thus, no extra check is required.

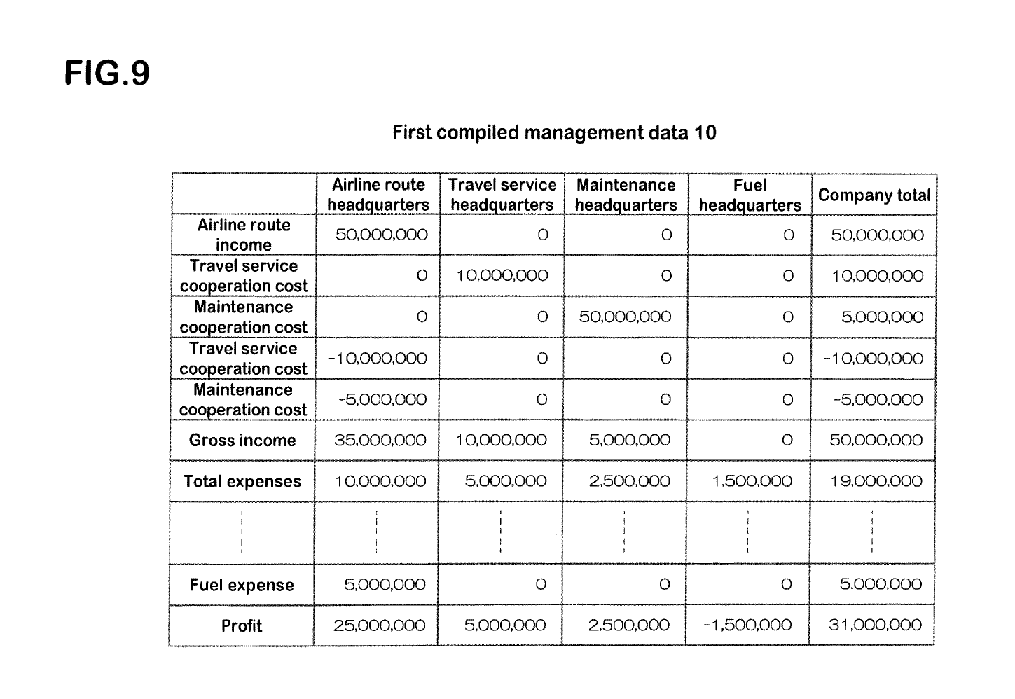

Next, the CPU 20 compiles the accounting data and the generated compensation-for-cooperation data on a headquarters basis (excluding the airline route headquarters) to generate compiled management data (the step S7). FIG. 9 illustrates the compiled management data thus generated.

The CPU 20 calculates a total of the airline route incomes and individual totals of the travel service cooperation costs, the maintenance cooperation costs, and so on in the compensation-for-cooperation data on a headquarters basis. Then, the CPU 20 adds the totals together to calculate gross income. In addition, the CPU 20 calculates individual totals of the respective expenses including the fuel expense, and adds the totals together to calculate total expenses. Further, the CPU 20 subtracts the total expenses from the gross income to calculate a profit.

Next, the CPU 20 compiles the compiled management data on the respective headquarters including the airline route headquarters to generate first compiled management data (step S8). As shown in FIG. 9, the CPU 20 calculates the incomes and expenses of the whole company including the airline route headquarters.

The calculated first compiled management data 10 helps to clarify the incomes and expenses on a headquarters basis, while helping to specifying a breakdown of the incomes and a breakdown of the expenses. This can be reflected to the management policy.

In this embodiment, as shown in FIG. 2, an intersection area (x) between any one of the headquarters and any one of the airline routes may be defined as a minimum unit if necessary, so that the incomes and expenses of the minimum unit may be calculated. This allows management of the incomes and expenses on a detailed unit basis combining a really existing department and a virtual organization. In other words, the management on a detailed unit basis allows further understanding of the expenses derived from each headquarters on an airline route basis. This makes it possible to obtain some information to review the percentage of the compensation-for-cooperation and the unit price for each airline route or each headquarters through comprehensively understanding the expenses of all the headquarters or other airline routes. This enables efficient business management.

### 4. Other Embodiment

In the aforementioned embodiment of the present invention, the CPU 20 does not compile the data on the airline route headquarters in the step S7. The reason for this is that the CPU 20 has already summed the data on the airline route headquarters in the step S6. However, the CPU 20 may skip the step S6, and may sum the data on the airline route headquarters in the step S7. Furthermore, the CPU 20 may sum the data on the airline route headquarters both in the step S6 and the step 7 in order to prove the calculation.

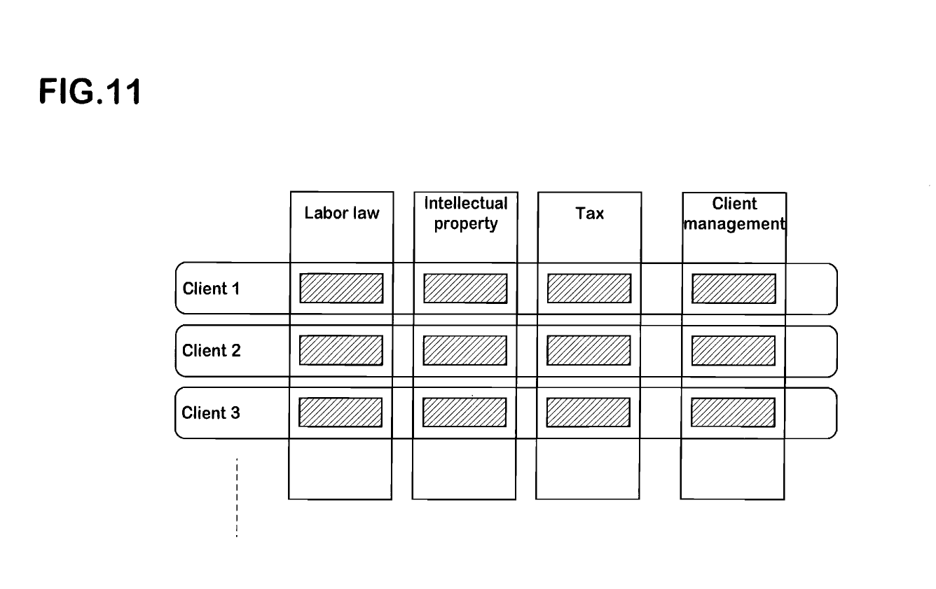

In the aforementioned embodiment, the airline company has been described as an example. However, the present invention may also be applied to other service businesses. For example, as shown in FIG. 11, the present invention may also be applied to a general law firm or the like, in which there are for example a labor law department, an intellectual property department, a tax department, a client management department and so on as really existing department and the client management department controls operations between these departments.

In the aforementioned embodiment, the present invention is applied to the service businesses. However, the present invention may also be applied to manufacturing businesses. For example, the present invention may also be applied to such a manufacturer that establishes departments in charge of respective manufacturing processes as really existing in-house organizations, products as virtual in-house organizations, and a management department that controls all the products.

This allows the manufacturer to understand expenses derived from each manufacturing process on a product basis. This makes it possible to obtain information to review the percentage of the compensation-for-cooperation and the unit price for each product or each process through comprehensively understanding the expenses of all the processes or other products. This enables efficient business management.

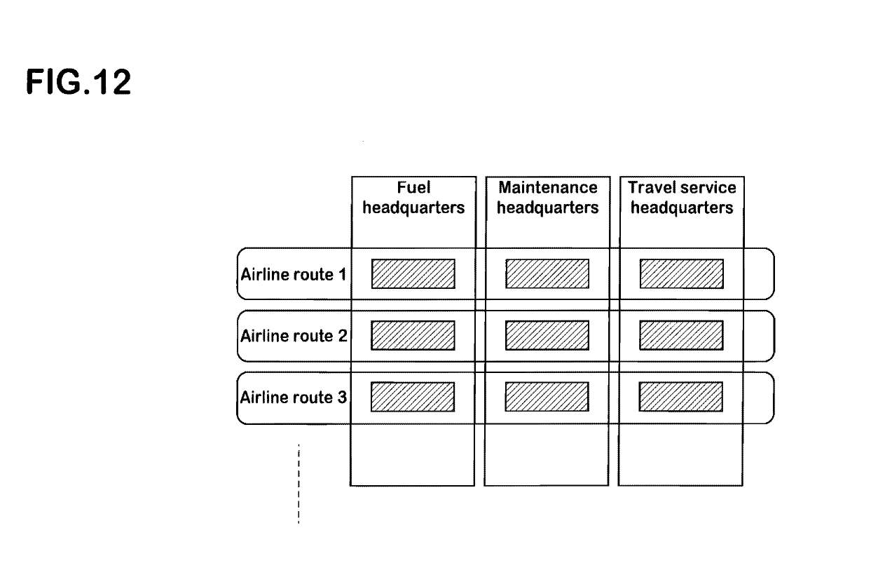

Furthermore, in the aforementioned embodiments, the really existing in-house organization that controls the virtual in-house organizations is established to receive incomes. However, as shown in FIG. 12, no really existing in-house organization that controls the virtual in-house organizations may be established. In this case, any of the really existing organizations may receive the incomes derived from services or goods. The other embodiment shown in FIG. 12 may be applied either to service businesses or to manufacturing businesses.

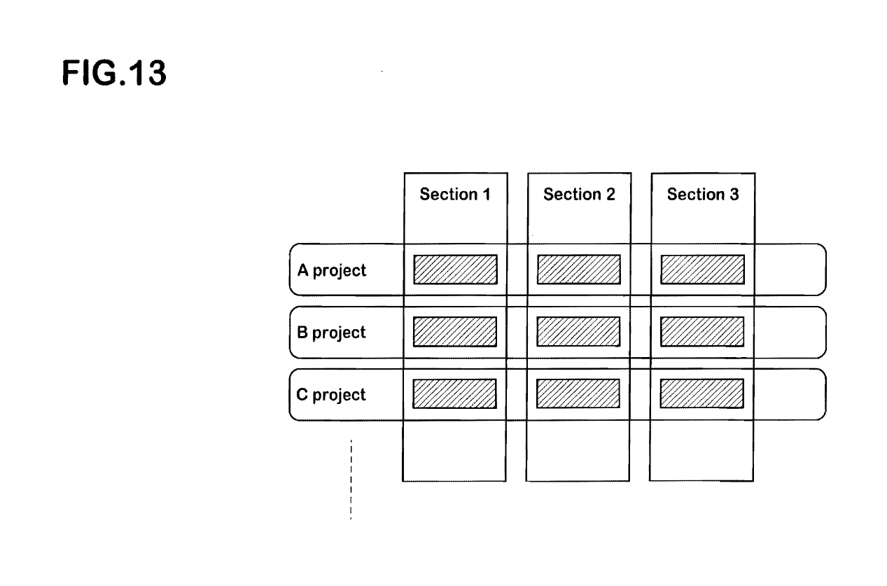

In the aforementioned embodiments, the virtual in-house organizations are established. However, the present invention may also be applied to a case where second really existing in-house organizations are established with a relationship with the really existing in-house organizations as shown in FIG. 13. For example, ordinary really existing in-house organizations may be defined as primary really existing in-house organizations, while project teams may be defined as secondary really existing in-house organizations.

Furthermore, the present invention may also be applied to a case where an additional ordinary really existing in-house organization is established in addition to the ordinary really existing in-house organizations shown in FIG. 13 to control all the projects.

Still furthermore, the present invention may also be applied to a case where the virtual in-house organizations and the secondary really existing in-house organizations are mixed together.

In the aforementioned embodiment, the incomes derived from each airline route are allocated to the respective headquarters, as shown in FIG. 2. This allows a calculation of the incomes and expenses on a matrix unit (x) basis. The matrix is defined between one of the really existing in-house organizations and one of the virtual in-house organizations. It should be understood that the incomes derived from each airline route may not be always allocated in the aforementioned manner. The accounting data including income data and expense data, which is associated with each unit (x), may be inputted to generate management data on each unit (x). In this case, the accounting data in FIG. 4 needs to specify the names of the virtual in-house organizations on the third line to the fifth line.

In the aforementioned embodiment, the compensation-for-cooperation data is generated based on compensation for supplies of services or goods from the other departments, as an example. These supplies are required to obtain the airline route incomes. However, in a case where intermediate products, parts or raw materials are purchased from an Amoeba (trademark) in charge of the previous process or in a case where machining services are supplied from another Amoeba (trademark), these purchases and supplies may be treated as part of the compensation-for-cooperation data.

1. A business management system comprising:
a recording part that records first compiled management data on each of a plurality of really existing in-house organizations, second compiled management data on each of a plurality of virtual in-house organizations that are established across the plurality of really existing in-house organizations, and a compensation-for-cooperation table, in which the first compiled management data includes: income data derived from a supply of services or a sale of goods; compensation-for-cooperation data for the other really existing in-house organization; expense data; and profit data, the second compiled management data includes: income data derived from a supply of services or a sale of goods; compensation-for-cooperation data for the really existing in-house organization; expense data; and profit data, and the compensation-for-cooperation table is designed to determine a monetary value of cooperative buying and selling between the virtual in-house organization and the really existing in-house organization, corresponding to the income data;
inputting part which inputs accounting data including the income data associated with the virtual in-house organization and the expense data;
means for generating compensation-for-cooperation data including at least in-house income data of the really existing in-house organization from the virtual in-house organization by referring to the compensation-for-cooperation table in response to the income data associated with the virtual in-house organization; and
means for generating first compiled management data including the profit data calculated by compiling the inputted income data and the expense data associated with the virtual in-house organization, and the generated compensation-for-cooperation data on the really existing in-house organization basis and for generating second compiled management data including the profit data calculated by compiling the inputted income data and the expense data associated with the virtual in-house organization, and the generated compensation-for-cooperation data on the virtual in-house organization basis.

2. A business management program for causing a computer to execute a business management system that generates first compiled management data on each of a plurality of really existing in-house organizations and second compiled management data on each of a plurality of virtual in-house organizations that are established across the plurality of really existing in-house organizations, in which the first compiled management data includes: income data derived from a supply of services or a sale of goods; compensation-for-cooperation data for the other really existing in-house organization; expense data; and profit data, and the second compiled management data includes: income data derived from a supply of services or a sale of goods; compensation-for-cooperation data for the really existing in-house organization; expense data; and profit data, the computer having a recording part that records a compensation-for-cooperation table designed to determine a monetary value of cooperative buying and selling between the virtual in-house organization and the really existing in-house organization, corresponding to the income data, the business management program causing the computer to execute:
means for generating compensation-for-cooperation data including at least in-house income data of the really existing in-house organization from the virtual in-house organization by referring to the compensation-for-cooperation table in response to the income data associated with the virtual in-house organization; and
means for generating first compiled management data including the profit data calculated by compiling the inputted income data and the expense data associated with the virtual in-house organization, and the generated compensation-for-cooperation data on the really existing in-house organization basis and for generating second compiled management data including the profit data calculated by compiling the inputted income data and the expense data associated with the virtual in-house organization, and the generated compensation-for-cooperation data on the virtual in-house organization basis.

3. The business management program according to claim 2, wherein
the compensation-for-cooperation data generating means generates the compensation-for-cooperation data including: the in-house income data on the really existing in-house organization in relation to the corresponding virtual in-house organization; and in-house cost data on the virtual in-house organization corresponding to the in-house income data.

4. The business management program according to claim 2, wherein
the compensation-for-cooperation data generating means generates the compensation-for-cooperation data including: the expense data on the virtual in-house organization; and expense data on the really existing in-house organization corresponding to the expense data on the virtual in-house organization, and the expense data on the really existing in-house organization is shown as a negative number.

5. The business management program according to claim 2, wherein
data that integrates the second compiled management data on the respective virtual in-house organizations is equal to the first compiled management data on the really existing in-house organization into which the virtual in-house organizations are integrated.

6. The business management program according to claim 2, wherein
a secondary really existing in-house organization is used in place of, or in addition to, the virtual in-house organization, and the secondary really existing in-house organization is organized across the really existing in-house organizations.

7. A business management method that generates first compiled management data on each of a plurality of really existing in-house organizations and second compiled management data on each of a plurality of virtual in-house organizations that are established across the plurality of really existing in-house organizations, in which the first compiled management data includes: income data derived from a supply of services or a sale of goods; compensation-for-cooperation data for the other really existing in-house organization; expense data; and profit data, and the second compiled management data includes: income data derived from a supply of services or a sale of goods; compensation-for-cooperation data for the really existing in-house organization; expense data; and profit data, the business management method being executed by a computer having a recording part that records a compensation-for-cooperation table designed to determine a monetary value of cooperative buying and selling between the virtual in-house organization and the really existing in-house organization, corresponding to the income data;
the computer performs the steps of:
generating compensation-for-cooperation data including at least in-house income data of the really existing in-house organization from the virtual in-house organization by referring to the compensation-for-cooperation table in response to the income data associated with the virtual in-house organization; and
generating first compiled management data including the profit data calculated by compiling the inputted income data and the expense data associated with the virtual in-house organization, and the generated compensation-for-cooperation data on the really existing in-house organization basis and for generating second compiled management data including the profit data calculated by compiling the inputted income data and the expense data associated with the virtual in-house organization, and the generated compensation-for-cooperation data on the virtual in-house organization basis.
